(19) United States
(12) Patent Application Publication
(10) Pub. No.: US 2013/0057454 A1
(43) Pub. Date: Mar. 7, 2013

(54) User Configurable Apparatus

(71) Applicants: Bror Lennart Svarfvar, Littoinen (FI); Terho Otso Tapio Kaikuranta, Piispanristi (FI)

(72) Inventors: Bror Lennart Svarfvar, Littoinen (FI); Terho Otso Tapio Kaikuranta, Piispanristi (FI)

(73) Assignee: Nokia Corporation, Espoo (FI)

(21) Appl. No.: 13/638,059

(22) PCT Filed: Mar. 30, 2010
(86) PCT No.: PCT/IB10/51389

§ 371 Date: Nov. 7, 2012

(51) Int. Cl. G09G 5/00

(52) U.S. Cl. 345/1.3

(57) ABSTRACT

An apparatus including a central part, comprising a front face including a central display, a first side and a second side; peripheral parts including a first peripheral part, including a front face including a first display, and connected at the first side of the central part for rotation and a second peripheral part, including a front face including a second display, and connected at the second side of the central part for rotation; and a controller configured to control the displays and configured to initiate a first command in response to an actuation of a peripheral part and configured to initiate a second command in response to an actuation of a peripheral part

### FIELD OF THE INVENTION

Embodiments of the present invention relate to a user configurable apparatus.

### BACKGROUND TO THE INVENTION

Modern apparatus often have displays for displaying content to a person. Some apparatus are portable and are personal to a user. It may be desirable for a user of such an apparatus to control the operation of the apparatus in a convenient way while watching the display.

Additional dedicated keys can be provided but they may occupy area which could otherwise be used by the display.

A programmable soft keys can be provided that has a programmable function that is indicated by a legend in an adjacent display. However, although more functions can be provided with less keys they may still occupy area which could otherwise be used by the display.

A touch screen display can be provided that has active areas. However, the active areas may need to be labeled which would use part of the display that could be used for other uses. In addition, touching the touch screen display necessarily temporarily obscures at least part of the display and may leave an oily residue that may affect the quality of images displayed by the touch screen display.

### BRIEF DESCRIPTION OF VARIOUS EMBODIMENTS OF THE INVENTION

According to various, but not necessarily all, embodiments of the invention there is provided an apparatus comprising:
a central part, comprising a front face comprising a central display, a first side and a second side;
peripheral parts comprising
   a first peripheral part, comprising a front face comprising a first display, and connected at the first side of the central part for rotation and
   a second peripheral part, comprising a front face comprising a second display, and connected at the second side of the central part for rotation; and
a controller configured to control the displays and configured to initiate a first command in response to an actuation of a peripheral part and configured to initiate a second command in response to an actuation of a peripheral part.

According to various, but not necessarily all, embodiments of the invention there is provided an apparatus comprising:
a central part, comprising a front face comprising a display, a first side and a second side;
peripheral parts comprising:
   a first peripheral part connected to the first side of the central part for rotation to change a configuration of the apparatus and
   a second peripheral part connected to the second side of the central part for rotation to change a configuration of the apparatus;
a first sensor configured to detect relative rotation of the first peripheral part and the central part;
a second sensor configured to detect relative rotation of the second peripheral part and the central part; and
a controller configured to receive inputs from the first sensor and the second sensor and to detect different configurations of the apparatus as different user input commands.

According to various, but not necessarily all, embodiments of the invention there is provided a method comprising:
performing a first command in response to an actuation of a left peripheral part of an apparatus comprising a central part comprising a display, a left peripheral part that is rotatable relative to the central part and a right peripheral part that is rotatable relative to the central part; and
performing a second different command in response to actuation of the right peripheral part of the apparatus.

### BRIEF DESCRIPTION OF THE DRAWINGS

For a better understanding of various examples of embodiments of the present invention reference will now be made by way of example only to the accompanying drawings in which:

FIG. 1 schematically illustrates an apparatus comprising: a central part and peripheral parts;

FIG. 2 schematically illustrates some of the functional components of the apparatus;

FIGS. 3A, 3B, 3C schematically illustrate commands performed in response to user actuation of a peripheral part;

FIG. 4A schematically illustrates an expanded configuration of the apparatus;

FIG. 4B schematically illustrates a first contracted configuration of the apparatus;

FIG. 4C schematically illustrates a second contracted configuration of the apparatus;

FIG. 5A illustrates a display of a part in portrait;

FIG. 5B illustrates a display of a part in landscape;

FIG. 6 illustrates the displays of the parts arranged as a unitary display in landscape;

FIGS. 7A to 7I schematically illustrate the apparatus in different expanded configurations;

FIG. 8 illustrates a table identifying the possible different configurations of the apparatus and their associated commands;

FIGS. 9A and 9B illustrate an apparatus that has touch sensitive devices associated with the respective left peripheral part and the right peripheral part in an expanded configuration;

FIGS. 10A and 10B illustrate an apparatus that has touch sensitive devices associated with the respective left peripheral part and the right peripheral part in the first contracted configuration and the second contracted configuration.

### DETAILED DESCRIPTION OF VARIOUS EMBODIMENTS OF THE INVENTION

The Figures illustrate an apparatus 2 comprising: a central part 4, having a front face 3 comprising a central display 6, a left side 7 and a right side 5; peripheral parts 14, 24 and a controller 30. The peripheral parts 14, 24 include a left peripheral part 14 and a right peripheral part 24. The left peripheral part 14 has a front face 13 comprising a left display 16, and is connected at the left side 7 of the central part 4 for rotation. The right peripheral part 24 has a front face 23 comprising a right display 26, and is connected at the right side 5 of the central part 4 for rotation. The controller 30 is configured to control the displays 6, 16, 26. The controller 30 is configured to initiate a first command 41₁ in response to an actuation of a peripheral part 14, 24 and configured to initiate a second command 41₂ in response to an actuation of a peripheral part 14, 24. The second command 41₂ may be the inverse of the first command 41₁.

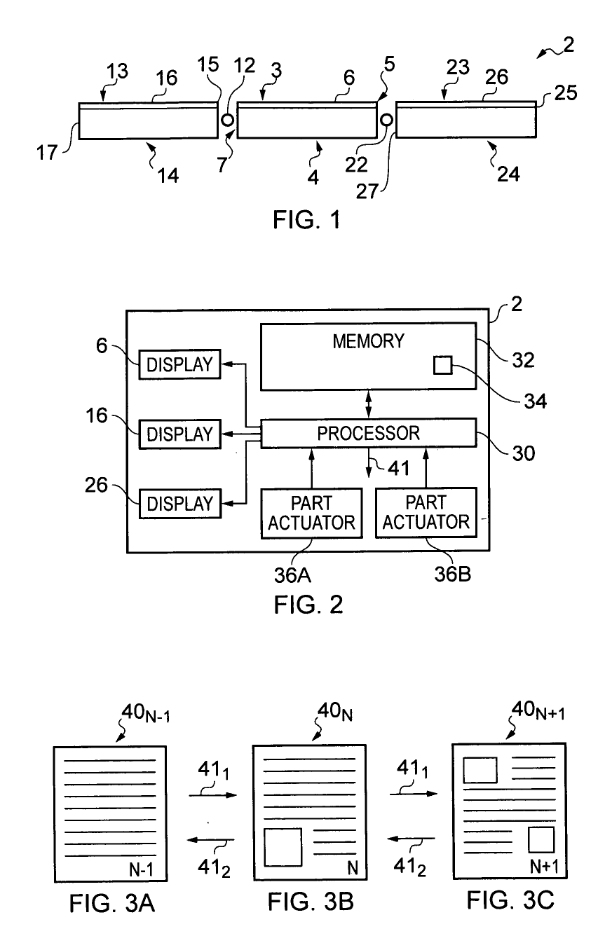

Referring to FIG. 1, FIG. 1 schematically illustrates an apparatus 2 comprising: a central part 4 and peripheral parts 14, 24. In this example there are only two peripheral parts but in other embodiments there may be more. The two peripheral parts 14, 24 consist of a left peripheral part 14 and a right peripheral part 24.

The central part 4 has a body or housing that has a front face 3, a left side 7 and an opposing right side 5. The front face comprises a central display 6, which may extend over the whole of the front face 3.

The left peripheral part 14 has a body or housing that has a front face 13, a left side 17 and an opposing right side 15. The front face 13 comprises a left display 16, which may extend over the whole of the front face 13.

The right peripheral part 24 has a body or housing that has a front face 23, a left side 27 and an opposing right side 25. The front face 23 comprises a right display 26, which may extend over the whole of the front face 23.

A left interconnect 12 interconnects the central part 4 and the left peripheral part 14. The left interconnect 12 is connected to the left side 7 of the central part 4 and to the right side 15 of the left peripheral part 14. The left interconnect 12 in this example enables folding rotation of the left peripheral part 14 about an axis of rotation that passes through the left interconnect 12 (into the page in the Figure) and parallel to both the left side 7 of the central part 4 and the right side 15 of the left peripheral part 14. The left interconnect 12 may be a hinge or similar. In other implementations, the left interconnect may additionally or alternately enable swiveling or twisting rotation of the left peripheral part 14 about an axis of rotation that is orthogonal to both the left side 7 of the central part 4 and the right side 15 of the left peripheral part 14.

The left interconnect 12 may, in addition to physically interconnecting the left peripheral part 14 and the central part 4, electronically interconnect the left peripheral part 14 and the central part 4.

A right interconnect 22 interconnects the central part 4 and the right peripheral part 24. The right interconnect 22 is connected to the right side 5 of the central part 4 and to the left side 27 of the right peripheral part 24. The right interconnect 22 in this example enables folding rotation of the right peripheral part 24 about an axis of rotation that passes through the right interconnect 22 (into the page in the Figure)) and parallel to both the right side 5 of the central part 4 and the left side 27 of the right peripheral part 24. The right interconnect 22 may be a hinge or similar. In other implementations, the right interconnect 22 may additionally or alternately enable swiveling or twisting rotation of the right peripheral part 24 about an axis of rotation that is orthogonal to both the right side 5 of the central part 4 and the left side 27 of the right peripheral part 24.

The right interconnect 22 may, in addition to physically interconnecting the right peripheral part 24 and the central part 4, electronically interconnect the right peripheral part 24 and the central part 4.

The apparatus 2 may be a hand-portable electronic device. It may be a pocketable device that is sized to fit into a suit pocket. It may be a personal electronic device such as a mobile cellular telephone, a personal music player, a personal video player, a ebook reader, a game console etc.

FIG. 2 schematically illustrates some of the functional components of the apparatus 2. A controller 30 is configured to control the displays 6, 16, 26.

The controller 30 may comprise, for example, one or more processors that drive the displays through a shared display driver or individual display drivers.

The controller 30 is also configured to receive an input from a left part actuator 36A and to receive an input from a right part actuator 36B.

The left part actuator 36A provides a signal to the controller 30 in response to an actuation of the left peripheral part 14. The actuation may, for example, be the rotational movement of the left peripheral part 14 relative to the central part 4 and the left part actuator 36A may detect or measure the rotational movement. The actuation may, for example, be the attempted rotational movement of the left peripheral part 14 relative to the central part 4 against a restraint or restraining force and the left part actuator 36A may detect or measure the force or torque. The actuation may, for example, be the actuation of a user touch sensitive device 36A at the left peripheral part 14.

The right part actuator 36B provides a signal to the controller 30 in response to an actuation of the right peripheral part 24. The actuation may, for example, be the rotational movement of the right peripheral part 24 relative to the central part 4 and the right part actuator 36B may detect or measure the rotational movement. The actuation may, for example, be the attempted rotational movement of the right peripheral part 24 relative to the central part 4 against a restraint or restraining force and the right part actuator 36B may detect or measure the force or torque. The actuation may, for example, be the actuation of a user touch sensitive device 36B at the right peripheral part 24.

Implementation of the controller can be in hardware alone (a circuit, a processor . . . ), have certain aspects in software including firmware alone or can be a combination of hardware and software (including firmware).

The controller may be implemented using instructions that enable hardware functionality, for example, by using executable computer program instructions in a general-purpose or special-purpose processor that may be stored on a computer readable storage medium (disk, memory etc) to be executed by such a processor.

The controller 30 in the illustrated example is provided by a processor 30 which reads computer program instructions 34 from a memory 32. The controller 30 is configured to initiate a command 41 in response to an actuation of a peripheral part. The command may be generated internally or externally to the controller but is evidence by a change in function of the apparatus 2.

The processor 30 is configured to read from and write to the memory 32. The processor 30 may also comprise an output interface via which data and/or commands are output by the processor 30 and an input interface via which data and/or commands are input to the processor 30.

The memory 32 stores a computer program 34 comprising computer program instructions that control the operation of the apparatus 2 when loaded into the processor. The computer program instructions 34 provide the logic and routines that enables the apparatus to perform the methods of the controller. The processor 30 by reading the memory 32 is able to load and execute the computer program 34.

The computer program may arrive at the apparatus 2 via any suitable delivery mechanism. The delivery mechanism may be, for example, a computer-readable storage medium, a computer program product, a memory device, a record medium such as a CD-ROM or DVD, an article of manufacture that tangibly embodies the computer program. The delivery mechanism may be a signal configured to reliably transfer the computer program.

The apparatus 2 may propagate or transmit the computer program 34 as a computer data signal.

Although the memory 32 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

Referring to FIGS. 3A, 3B, 3C, the controller 30 is configured to initiate a command 41 in response to an actuation of a peripheral part. In this example, the controller is configured to initiate a first command 41₁ in response to a first actuation of the left peripheral part 14 and is configured to initiate a second command 41₂ in response to a first actuation of the right peripheral part 24 or a second actuation of the left peripheral part 14.

The second command 41₂ may be the inverse of the first command 41₁. That is the first command 41₁ performs a function that is undone if immediately followed by the second command 41₂.

In the illustrated example, the first command 41₁ is a navigation command that results in currently displayed content 40_{N} being replaced by content 40_{N+1} that follows the currently displayed content 40_{N} and the second command 41₂ is a navigation command that results in currently displayed content 40_{N} being replaced by content 40_{N-1} that precedes the currently displayed content 40_{N}. In the illustrated example, the content 40_{N} is the Nth page of a document such as a book or web page. In other examples, the content may be photographs in a photograph album, or frames in video, or scenes or chapters in a movie, or chapters in a book etc.

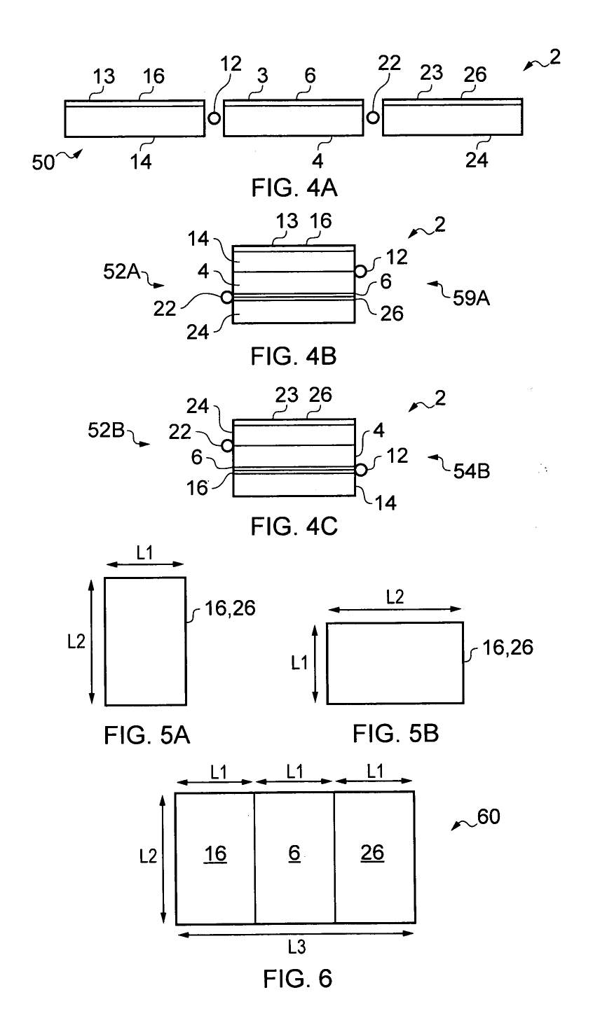

FIG. 4A schematically illustrates an expanded configuration 50 of the apparatus 2 which is similar to FIG. 1. The front face 13 of the left peripheral part 14, the front face 3 of the central part 4 and the front face 23 of the right peripheral part 24 are co-planar and form a front face of the apparatus 2. The left peripheral part 14, the central part 4 and the right peripheral part 24, in this illustrated example, are also aligned as co-planar.

In the expanded configuration, the controller 30 is configured to initiate a command 41 in response to an actuation of a peripheral part.

In the expanded configuration, the left peripheral part 14, the central part 4 and the right peripheral part 24 are aligned such and the left display 16, the central display 6 and the left display 26 are arranged as and controlled as a unitary display 60 as illustrated in FIG. 6. Unitary in this context means that the controller can display the displays 6, 16, 26 such that content can extend across the boundary between the displays 6, 16, 26.

Each of the left peripheral part 14, the central part 4, and the right peripheral part 24 have a length, a width and a depth. The length L2 and width L1 define the respective displays 16, 6, 26 of the parts. The lengths of the displays 16, 6, 26 are the same. The widths of the displays 16, 6, 26 are the same.

FIG. 5A illustrates any one of the displays 16, 6, 26 in portrait. FIG. 5B illustrates any one of the displays 16, 6, 26 in landscape. The height to width aspect ratio in landscape is L1/L2.

FIG. 6 illustrates the displays 16, 6, 26 arranged as a unitary display in landscape. The height to width aspect ratio in landscape is L2/3*L1.

In some embodiments the aspect ratio for one display in landscape matches the aspect ratio for the unitary display in landscape e.g. L1/L2=L2/3*L1, which results in L2=3^{1/2}L1(L2˜1.73L1).

In other embodiments the display 16 may have a width L_{A} instead of L1, the display 6 may have a width L_{B} instead of L1, and the display 16 may have a width L_{C} instead of L1, where L_{A} does not equal L_{B} and L_{C} does not equal L_{B}. In this embodiment, the aspect ratio for the display 6 in landscape will match the aspect ratio for the unitary display in landscape when. L_{B}/L2=L2/(L_{A}+L_{B}+L_{C}), which results in L2=(L_{B}*(L_{A}+L_{B}+L_{C}))^{1/2}.

FIG. 4B schematically illustrates a contracted configuration 52A of the apparatus 2. The front face 13 of the left peripheral part 14 forms a front face of the apparatus 2. The left peripheral part 14 is the uppermost part of the apparatus 2, the central part 4 is positioned directly under the left peripheral part 14 and the right peripheral part 24 is positioned directly under the central part 4 to form a stack 54A. The central display 6 and the right display 26 are concealed, whereas the left display 16 is exposed.

In this example, each of the left peripheral part 14, the central part 4, and the right peripheral part 24 have a length, a width and a depth. The length L2 and width L1 define the respective front faces 13, 3, 23 of the parts. The lengths of the parts 14, 4, 24 are the same and the widths of the parts 14, 4, 24 are the same such that in the stack 54A the edges of the parts are aligned.

In the contracted configuration 52A, the controller 30 may be configured to initiate a command 41 in response to an actuation of the right peripheral part 24 only.

Moving from the expanded configuration 50 to the contracted configuration 52A, involves moving the right peripheral portion 180 degrees anti-clockwise relative to the central part 4 and moving the left peripheral portion 180 degrees anti-clockwise relative to the central part 4.

Moving from the contracted configuration 52A to the expanded configuration 50, involves moving the right peripheral portion 180 degrees clockwise relative to the central part 4 and moving the left peripheral portion 180 degrees clockwise relative to the central part 4.

FIG. 4C schematically illustrates a contracted configuration 52B of the apparatus 2. The front face 23 of the right peripheral part 24 forms a front face of the apparatus 2. The right peripheral part 14 is the uppermost part of the apparatus 2, the central part 4 is positioned directly under the right peripheral part 24 and the left peripheral part 14 is positioned directly under the central part 4 to form a stack 54B. The central display 6 and the left display 16 are concealed, whereas the right display 26 is exposed.

In this example, each of the left peripheral part 14, the central part 4, and the right peripheral part 24 have a length, a width and a depth. The length L2 and width L1 define the respective front faces 13, 3, 23 of the parts. The lengths of the parts 14, 4, 24 are the same and the width of the parts 14, 4, 24 are the same such that in the stack 54B the edges of the parts are aligned.

In the contracted configuration 52B, the controller 30 may be configured to initiate a command 41 in response to an actuation of the left peripheral part 24 only.

Moving from the expanded configuration 50 to the contracted configuration 52B, involves moving the right peripheral portion 180 degrees clockwise relative to the central part 4 and moving the left peripheral portion 180 degrees clockwise relative to the central part 4.

Moving from the contracted configuration 52A to the expanded configuration 50, involves moving the right peripheral portion 180 degrees anti-clockwise relative to the central part 4 and moving the left peripheral portion 180 degrees anti-clockwise relative to the central part 4.

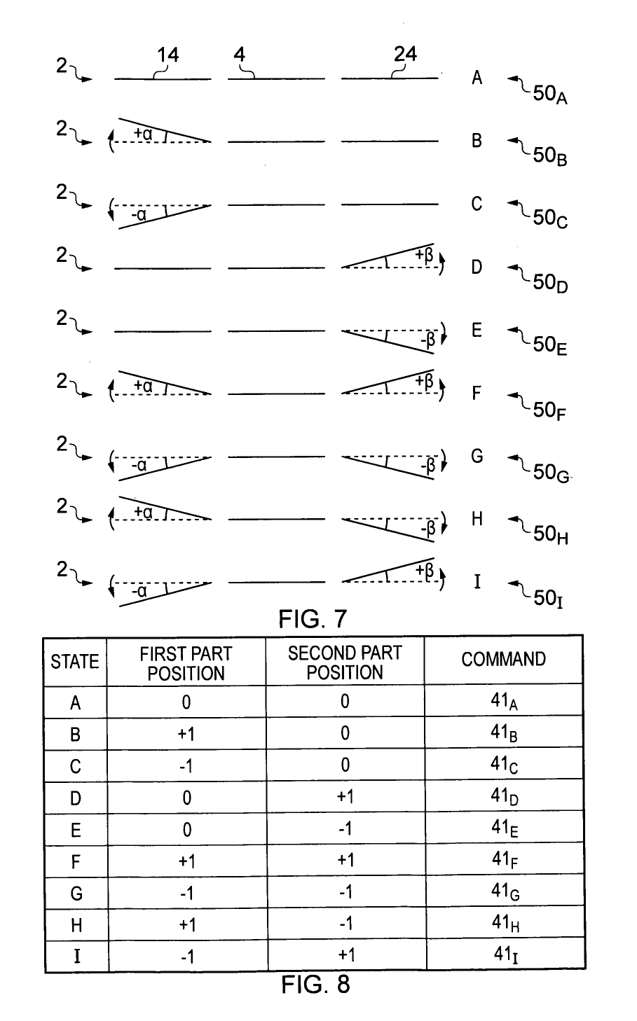

FIGS. 7A to 7I schematically illustrate the apparatus 2 in different expanded configurations 50ᵢ where i=A, B . . . I.

As previously described, the apparatus 2 comprises: a central part 4, having a front face 3 comprising a central display 6, a left side and a right side; peripheral parts 14, 24 including: a left peripheral part 14 connected to the left side of the central part 4 for rotation and a right peripheral part 24 connected to the right side of the central part 4 for rotation; a first sensor 36A configured to detect relative rotation of the left peripheral part 14 and the central part 4; a second sensor 36B configured to detect relative rotation of the right peripheral part 24 and the central part 4. The controller 30 may be configured to detect different configurations of the central and peripheral parts as different user input commands.

In this embodiment, the left part actuator 36A is a sensor configured to detect relative rotation of the left peripheral part 14 and the central part 4. The right part actuator 36B is a sensor configured to detect relative rotation of the right peripheral part 14 and the central part 4.

In this embodiment, the left display 16 and the right display 26 may be present or absent and the peripheral portions may be the same size as the central part or may be different sizes.

In FIGS. 7A to 7I, the left peripheral part 14 can take anyone of three different orientations relative to the central part 4. It may be level with the central part 4 as illustrated in FIG. 4A (FIGS. 7A, D, E). It may be positively offset by an angle α by clockwise rotation relative to the central part 4 (FIGS. 7B, F, H). It may be negatively offset by an angle α by anti-clockwise rotation relative to the central part 4 (FIGS. 7C, G, I).

In FIGS. 7A to 7I, the right peripheral part 24 can take anyone of three different orientations relative to the central part 4. It may be level with the central part 4 as illustrated in FIG. 4A (FIGS. 7A, B, C). It may be positively offset by an angle β by anti-clockwise rotation relative to the central part 4 (FIGS. 7D, F, I). It may be negatively offset by an angle β by clockwise rotation relative to the central part 4 (FIGS. 7E, G, H)

The table illustrated in FIG. 8 illustrates the possible different configurations. A positive offset is represent by +1, no offset is represented by 0 and a negative offset is represented by −1. The different expanded configurations 50ᵢ of the apparatus 2 can be defined using an input state vector in which the first component represents the offset of the left peripheral part 14 and second component represents the offset of the right peripheral part 24. The vectors are respectively for FIGS. 7A to 7I (00), (10), (−10), (01), (0-1), (11), (−1-1), (1-1), (−1, 1).

Different expanded configurations 50ᵢ may be associated with different user input commands 41ᵢ. the user input commands may be predefined. Alternatively or additionally the user input commands may be defined by a user.

The user input commands may be context sensitive. That is, as the context of the apparatus changes, the user input commands change. Thus the user input commands may be dependent upon what application is running or what content is being displayed or even time of day.

The controller 30 is configured to initiate a first command 41ᵢ in response to relative rotation of a peripheral part 14, 24 relative to the central part 4 in a clockwise direction and configured to initiate a second command 41ⱼ in response to relative rotation of a peripheral part 14, 24 relative to the central part 4 in an anti-clockwise direction. The second command 41ⱼ may be the inverse of the first command 41ᵢ. The index I may have any of the values A, B . . . I and the index j may have any of the values A, B . . . I.

As an example, the controller 30 may be configured to initiate a first navigation command 41₁ in response to relative rotation of the right peripheral parts 24 relative to the central part 4 in a clockwise direction and may be configured to initiate a second navigation command 41₂ in response to relative rotation of the left peripheral part 14 relative to the central part 4 in an anti-clockwise direction.

As another example, the controller 30 may be configured to initiate a first navigation command 41₁ in response to relative rotation of the left peripheral part 14 relative to the central part 4 in a clockwise direction and configured to initiate a second navigation command 41₂ initiated in response to relative rotation of the left peripheral part 14 relative to the central part 4 in an anti-clockwise direction.

In the above described example, three input states were defined for each peripheral part. In this example the input states where based upon the extent and sense of rotation. It should therefore be appreciated that the above example may be generalized such that each peripheral part has M input states represented by, for example, M different rotations. In some embodiments, parameters other that displacement may be used to generate more input states such as speed of rotation, or acceleration of rotation or even applied force. The controller 30 maybe configured to detect or discriminate the parameters. The combination of an input state for the left peripheral part 14 and the right peripheral part 24 defines an input state vector for the apparatus. Each particular input state vector may be associated with a different command 41.

The associations between the input state vectors and the commands 41 may be varied, for example, when the apparatus enters a contracted configuration 52 or exits the expanded configuration 50.

The associations between the input state vectors and the commands 41 may be varied by user programming.

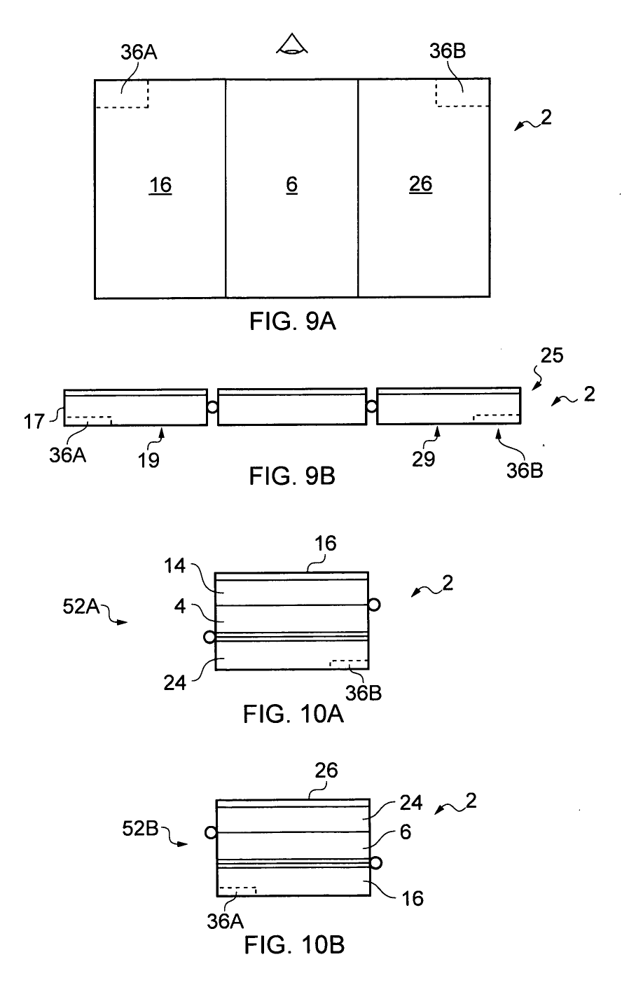

FIGS. 9A and 9B illustrate an apparatus 2 that alternately or additionally has touch sensitive devices 36A, 36B associated with the respective left peripheral part 16 and the right peripheral part 26.

The left touch sensitive device 36A is positioned on a rear portion 19 of the left peripheral part 14 towards at least the left side 17 of the left peripheral part 14. The right touch sensitive device 36B is positioned on a rear portion 29 of the right peripheral part 24 towards at least the right side 25 of the right peripheral part 24.

The controller is configured to initiate a first command 41₁ in response to an actuation of the left touch sensitive device 36A of the left peripheral part 14. The controller is configured to initiate a second command 41₂ in response to an actuation of the right touch sensitive device 36A of the left peripheral part 14.

FIGS. 10A and 10B schematically illustrate the apparatus 2 that is illustrated in FIGS. 9A and 9B in the expanded configuration, when it is in the contracted configuration 52A (FIG. 10A) and when it is in the contracted configuration 52B (FIG. 10B).

In the contracted configuration 52A, the left touch sensitive device 36A positioned on the rear portion 19 of the left peripheral part 14 is concealed preventing user actuation and the right touch sensitive device 36B positioned on the rear portion 29 of the right peripheral part 24 is exposed for user actuation.

In the contracted configuration 52B, the left touch sensitive device 36A positioned on the rear portion 19 of the left peripheral part 14 is exposed for user actuation and the right touch sensitive device 36B positioned on the rear portion 29 of the right peripheral part 24 is concealed preventing user actuation.

The function of the left touch sensitive device 36A may change. When the apparatus is in the expanded configuration 50 it may have a first function and when the apparatus 2 is in the contracted configuration 52B it may have a different function.

The function of the left touch sensitive device 36A may also change from when the apparatus is in the expanded configuration 50 to when the apparatus 2 is in the contracted configuration 52B.

Although embodiments of the present invention have been described in the preceding paragraphs with reference to various examples, it should be appreciated that modifications to the examples given can be made without departing from the scope of the invention as claimed. For example, although the preceding description describes a left peripheral part connected to a left side of a central part and a right peripheral part connected to a right side of the central part, in other embodiments the left and right peripheral parts may be replaced or augmented with a top peripheral part connected to a top side of the central part and a bottom peripheral part connected to a bottom side of the central part.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus comprising:
a central part, comprising a front face comprising a central display, a first side and a second side;
peripheral parts comprising
a first peripheral part, comprising a front face comprising a first display, and connected at the first side of the central part for rotation and a second peripheral part, comprising a front face comprising a second display, and connected at the second side of the central part for rotation; and
a controller configured to control the displays and configured to initiate a first command in response to an actuation of a peripheral part and configured to initiate a second command in response to an actuation of a peripheral part.

2. An apparatus as claimed in claim 1, wherein the apparatus has an expanded configuration in which the first peripheral part, the central part and the second peripheral part are aligned such and the first display, the central display and the second display are controlled as a unitary display and the apparatus has a contracted configuration in which the first peripheral part, the central part and the second peripheral part are arranged as a stack in which the display of one of the peripheral parts is exposed and the displays of the other parts are concealed.

3. An apparatus as claimed in claim 2, wherein a first one of the peripheral portions is rotated through 180 degrees clockwise and a second one of the peripheral portions is rotated through 180 degrees clockwise to change from a contracted configuration to an expanded configuration and wherein a first one of the peripheral portions is rotated through 180 degrees anti-clockwise and a second one of the peripheral portions is rotated through 180 degrees anti-clockwise to change from the expanded configuration to the contracted configuration.

4. An apparatus as claimed in claim 1, wherein the first peripheral part has a first side and a second side, where the second side of the first peripheral part is connected to the first side of the central part and the second side of the first peripheral part has the same length dimension as the first side of the central part and wherein the second peripheral part has a first side and a second side, where the first side of the second peripheral ₚart is connected to the second side of the central part and the first side of the second peripheral part has the same length dimension as the second side of the central part.

5. An apparatus as claimed in claim 1, wherein the first command is a command resulting in currently displayed content being replaced by content that follows the currently displayed content and the second command is a navigation command resulting in currently displayed content being replaced by content that precedes the currently displayed content.

6. An apparatus as claimed in claim 1, further comprising a first sensor configured to detect relative rotation of the first peripheral part and the central part; and a second sensor configured to detect relative rotation of the second peripheral part and the central part.

7. An apparatus as claimed in claim 1, wherein the controller is configured to control the displays and configured to initiate the first command in response to relative rotation of a peripheral part relative to the central part in a clockwise direction and configured to initiate a second command in response to relative rotation of a peripheral part relative to the central part in an anti-clockwise direction, wherein the second command is the inverse of the first command.

8. An apparatus as claimed in claim 1, wherein the controller is configured to initiate a first command in response to relative rotation of a first one of the peripheral parts relative to the central part in a clockwise direction and configured to initiate a second command initiated in response to relative rotation of a second one of the peripheral parts relative to the central part in an anti-clockwise direction.

9. An apparatus as claimed in claim 1, wherein the controller is configured to initiate a first command in response to relative rotation of the a first one of the peripheral parts relative to the central part in a clockwise direction and configured to initiate a second command initiated in response to relative rotation of the first one of the peripheral parts relative to the central part in an anti-clockwise direction.

10. An apparatus as claimed in claim 1, wherein the controller is configured to control the displays and configured to detect different relative configurations of the central and peripheral parts as different user input commands.

11. An apparatus as claimed in claim 1, wherein the controller is configured to detect different input states that correspond to at least a combination of a rotational state of the first peripheral part and a rotational state of the second peripheral part, where the first peripheral part has at least three distinct rotational states corresponding to three different angles formed between the central part and the first peripheral part and where the second peripheral part has at least three distinct rotational states corresponding to three different angles formed between the central part and the second peripheral part.

12. An apparatus as claimed in claim 11, wherein the three different angles formed between the central part and the first peripheral part comprise a positive angle, a negative angle and a zero angle and wherein the three different angles formed between the central part and the second peripheral part comprise a positive angle, a negative angle and a zero angle.

13. An apparatus as claimed in claim 1, wherein the controller is configured to detect different input states that correspond to different rotational speeds of a peripheral part relative to the central part.

14. An apparatus as claimed in claim 1, wherein the first peripheral part comprises a first touch sensitive device and the second peripheral part comprises a second touch sensitive device and wherein actuation of a peripheral part involves actuation of a respective touch sensitive device of the peripheral part.

15. An apparatus as claimed in claim 14, wherein the first touch sensitive device is positioned on a rear portion of the first peripheral part and the second touch sensitive device is positioned on a rear portion of the second peripheral part.

16. An apparatus as claimed in claim 14, wherein the first touch sensitive device is positioned on a rear portion of the first peripheral part towards at least the first side of the first peripheral part and the second touch sensitive device is positioned on a rear portion of the second peripheral part towards at least the second side of the second peripheral part.

17. An apparatus as claimed in claim 1, wherein a first interconnect joins the first peripheral part and the central part and has an associated first sensor configured to measure the rotational force at the first interconnect and wherein a second interconnect joins the second peripheral part and the central part and has an associated second sensor configured to measure the rotational force at the second interconnect.

18. An apparatus as claimed in claim 1, wherein the apparatus is a hand-portable personal electronic device comprising a radio transceiver.

19. An apparatus comprising:
a central part, comprising a front face comprising a display, a first side and a second side;
peripheral parts comprising
a first peripheral part connected to the first side of the central part for rotation to change a configuration of the apparatus and
a second peripheral part connected to the second side of the central part for rotation to change a configuration of the apparatus;
a first sensor configured to detect relative rotation of the first peripheral part and the central part;
a second sensor configured to detect relative rotation of the second peripheral part and the central part; and
a controller configured to receive inputs from the first sensor and the second sensor and to detect different configurations of the apparatus as different user input commands.

20. A method comprising:
performing a first command in response to an actuation of a left peripheral part of an apparatus comprising a central part comprising a display, a left peripheral part that is rotatable relative to the central part and a right peripheral part that is rotatable relative to the central part; and performing a second different command in response to actuation of the right peripheral part of the apparatus.

21. A method as claimed in claim 20 comprising:
detecting rotation of the left peripheral part relative to the central part as an actuation of the left peripheral part; and
detecting rotation of the right peripheral part relative to the central part as an actuation of the right peripheral part.

22. A method as claimed in claim 20 comprising:
detecting actuation of a touch sensitive device located on a rear of the left peripheral part as an actuation of the left peripheral part; and
detecting actuation of a touch sensitive device located on a rear of the right peripheral part as an actuation of the right peripheral part.
